(19) United States
(12) Patent Application Publication
(10) Pub. No.: US 2022/0294031 A1
(43) Pub. Date: Sep. 15, 2022

(54) METAL-SHELL BATTERY AND ELECTRONIC DEVICE

(71) Applicant: Dongguan NVT Technology Limited, Dongguan (CN)

(72) Inventors: Zhaohua Ouyang, Dongguan (CN); Yuanfan Deng, Dongguan (CN); Yibin Zhong, Dongguan (CN); Wei Tang, Dongguan (CN)

(73) Assignee: Dongguan NVT Technology Limited, Dongguan (CN)

(21) Appl. No.: 17/722,610

(22) Filed: Apr. 18, 2022

(30) Foreign Application Priority Data
Mar. 15, 2021 (CN) 202120535992.3

(51) Int. Cl. H01M 10/42; H01M 50/593; H01M 50/119; H01M 50/534

(52) U.S. Cl. CPC H01M 10/425; H01M 50/593; H01M 50/119; H01M 50/534

(57) ABSTRACT

A metal-shell battery includes: a cell including a metal housing and an electrode assembly sealed in the metal housing; a first conductive sheet; and a second conductive sheet. The metal housing includes a first surface. An electrode post is disposed protrusively on the first surface and is insulated from the metal housing. Two electrodes of the electrode assembly are electrically connected to the electrode post and the metal housing respectively. One end of the first conductive sheet is connected to the first surface. One end of the second conductive sheet is connected to the electrode post. A circuit board is connected to the other end of the first conductive sheet and the other end of the second conductive sheet respectively. |S1-S2|≤1 mm, S1 and S2 are distances between the first surface, and the one end and the other end of the circuit board respectively.

### CROSS REFERENCE TO THE RELATED APPLICATION

The present application claims the priority of Chinese Patent Application No. 202120535992.3, filed on Mar. 15, 2021, the entire content of which is incorporated herein by reference.

### TECHNICAL FIELD

This application relates to the technical field of batteries, and in particular, to a metal-shell battery and an electronic device.

### BACKGROUND

With the rapid development of science and technology, more and more electronic products are emerging. To meet mobility requirements of users in diverse scenarios, the electronic products are increasingly smaller in size and weight but are increasingly powerful in functionality. Therefore, harsher requirements are posed on a battery that serves as a power source of the electronic products. Currently, a battery that uses a nickel-plated steel shell as an outer shell is applied more widely by good features such as high rigidity, resistance to pressure, and resistance to deformation.

It is found that, in the metal-shell battery, a circuit board is usually fitted snugly to the two electrodes of the metal-shell battery to minimize a distance between the circuit board and the two electrodes of the metal-shell battery. However, a distance between one electrode of the metal-shell battery and the circuit board is different from a distance between the other electrode and the circuit board. Consequently, the circuit board is disposed obliquely against the metal housing and therefore occupies more installation space, thereby being detrimental to miniaturization and lightweight design of the metal-shell battery.

### SUMMARY

Embodiments of this application provide a metal-shell battery and an electronic device to reduce installation space occupied by a circuit board, and in turn, reduce space occupied by the metal-shell battery, so as to meet miniaturization and lightweight requirements of the metal-shell battery.

To solve the foregoing technical problem, a technical solution adopted by the embodiments of this application is: a metal-shell battery is provided, where the metal-shell battery includes a cell. The cell includes a metal housing and an electrode assembly sealed in the metal housing. The metal housing includes a first surface. An electrode post is disposed protrusively on the first surface. The electrode post is insulated from the metal housing. Two electrodes of the electrode assembly are electrically connected to the electrode post and the metal housing respectively. The metal-shell battery further includes: a first conductive sheet, where one end of the first conductive sheet is connected to the first surface; a second conductive sheet, where one end of the second conductive sheet is connected to the electrode post; and a circuit board, connected to the other end of the first conductive sheet and the other end of the second conductive sheet respectively. A distance between one end of the circuit board along a length direction of the circuit board and the first surface is a first spacing S1, a distance between the other end of the circuit board along the length direction of the circuit board and the first surface is a second spacing S2, and S1 and S2 satisfy: |S1-S2|≤1 mm.

Optionally, the circuit board includes a first plane. The other end of the first conductive sheet and the other end of the second conductive sheet are both connected to the first plane.

Optionally, the first plane is disposed at an angle to the first surface, and the angle α1 between the first plane and the first surface satisfies 0°≤α1≤30°.

Optionally, the first plane is disposed at an angle to the first surface, and the angle α2 between the first plane and the first surface satisfies 80°≤α2≤100°.

Optionally, the metal-shell battery further includes an insulation filler. The insulation filler is disposed between the first surface and the circuit board.

Optionally, the metal-shell battery further includes a pantograph strip. The pantograph strip is disposed on the first surface. One end of the first conductive sheet is connected to the first surface by the pantograph strip.

Optionally, the metal-shell battery further includes a protection piece. The protection piece is disposed on the first surface. The protection piece at least partly overlays the circuit board.

Optionally, the protection piece is formed by a potting process, an adhesive dispensing process, or a low-pressure injection molding process.

Optionally, the circuit board further includes a circuit board body and an output terminal, one end of the output terminal is connected to the circuit board body, and the other end of the output terminal protrudes from the protection piece.

To solve the foregoing technical problem, another technical solution adopted by the embodiments of this application is: an electronic device is provided, where the electronic device includes the metal-shell battery described above.

Beneficial effects of the embodiments of this application are: The metal-shell battery and the electronic device according to the embodiments of this application controls the spacing between the circuit board and the first surface of the metal housing, so that the circuit board is approximately parallel to the first surface, thereby making it convenient to affix insulation tape outside a protection circuit module or perform low-pressure injection molding on the protection circuit module to form a protective body. In addition, the installation space occupied by the circuit board is reduced, and in turn, the space occupied by the metal-shell battery is reduced, thereby meeting miniaturization and lightweight requirements of the metal-shell battery.

### BRIEF DESCRIPTION OF THE DRAWINGS

To describe the technical solutions in the embodiments of this application more clearly, the following outlines the drawings used in the embodiments of this application. Evidently, the drawings outlined below are merely a part of embodiments of this application. A person of ordinary skill in the art may derive other drawings from the outlined drawings without making any creative efforts.

FIG. 1 is a schematic structural diagram of a metal-shell battery according to a first embodiment of this application;

FIG. 2 is a structural exploded view of the metal-shell battery shown in FIG. 1;

FIG. 3 is a schematic structural diagram of a cell of the metal-shell battery shown in FIG. 1;

FIG. 4 is a schematic structural diagram of an unsealed state of a metal-shell battery according to a second embodiment of this application;

FIG. 5 is a schematic structural diagram of a metal-shell battery according to a third embodiment of this application;

FIG. 6 is a structural exploded view of the metal-shell battery shown in FIG. 5;

FIG. 7 is a schematic structural diagram of an unsealed state of the metal-shell battery shown in FIG. 5;

FIG. 8 is a schematic structural diagram of a metal-shell battery according to a fourth embodiment of this application; and

FIG. 9 is a schematic structural diagram of a metal-shell battery according to a fifth embodiment of this application.

### DETAILED DESCRIPTION

For ease of understanding this application, the following describes this application in more detail with reference to drawings and specific embodiments. It needs to be noted that an element referred to herein as being “fixed to” or “fastened to” another element may directly exist on the other element, or may be fixed or fastened to the other element through one or more intermediate elements. An element referred to herein as “connected to” another element may be connected to the other element directly or through one or more intermediate elements. The terms “vertical”, “horizontal”, “left”, “right”, “in”, “out” and other similar expressions used herein are merely for ease of description.

Unless otherwise defined, all technical and scientific terms used herein have the same meanings as what is generally understood by a person skilled in the technical field of this application. The terms used in the specification of this application are merely intended to describe specific embodiments but not to limit this application. The term “and/or” used herein is intended to include any and all combinations of one or more related items preceding and following the term.

In addition, the technical features described below and mentioned in different embodiments of this application may be combined with each other so long as they do not conflict with each other.

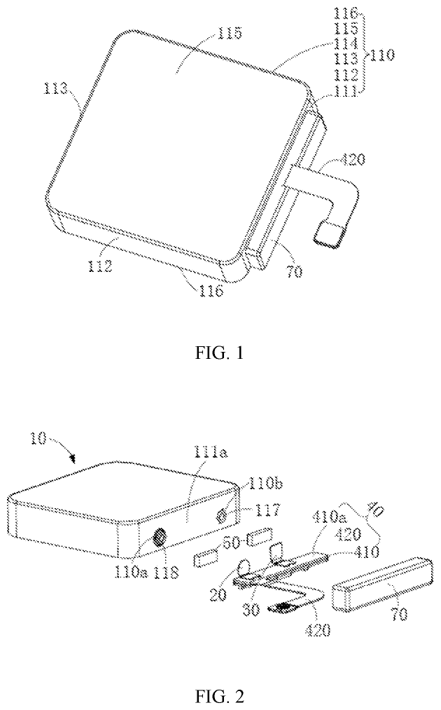

Refer to FIG. 1 and FIG. 2 together, which show a metal-shell battery according to a first embodiment of this application. The metal-shell battery includes a cell 10, a first conductive sheet 20, a second conductive sheet 30, and a circuit board 40. The cell 10 includes a metal housing 110 and an electrode assembly 120 sealed in the metal housing 110. One electrode of the electrode assembly 120 is connected to the metal housing 110. The other electrode of the electrode assembly 120 protrudes from a surface of the metal housing 110. In addition, the other electrode of the electrode assembly 120 is insulated from one electrode of the electrode assembly 120. One end of the first conductive sheet 20 is connected to the surface of the metal housing 110. The other end of the first conductive sheet 20 is connected to the circuit board 40. One end of the second conductive sheet 30 is connected to the other electrode of the cell 20. The other end of the second conductive sheet 30 is connected to the circuit board 40.

For ease of description, in this embodiment of this application, one electrode of the cell 20 is defined as a positive electrode of the cell 20, and the other electrode of the cell 20 is defined as a negative electrode of the cell 20. In addition, the circuit board is approximately a cuboid structure. Therefore, a length of the circuit board is defined as a maximum spacing between a pair of two opposite ends of the circuit board, a height of the circuit board is defined as a minimum spacing between the other pair of two opposite ends of the circuit board, and a width of the circuit board is defined as a spacing between the remaining pair of two opposite ends of the circuit board.

It is hereby noted that a distance between one end of the circuit board 40 along the length direction of the circuit board and a first surface 111a is a first spacing S1, and a distance between the other end of the circuit board 40 along the length direction of the circuit board and the first surface 111a is a second spacing S2. Preferably, S1 and S2 satisfy: |S1-S2|=0 mm. That is, in the length direction of the circuit board, the circuit board 40 is disposed parallel to the first surface 111a. However, during assembling, the step of fixing both the first conductive sheet 20 and the second conductive sheet 30 to the circuit board 40 inevitably causes a problem of an assembly tolerance. Therefore, the circuit board 40 is deemed parallel to the first surface 111a in the length direction of the circuit board even if |S1-S2| is less than or equal to 1 mm.

In this embodiment of this application, the spacing between the circuit board 40 and the surface of the metal housing 110 is controlled, so that the circuit board 40 is approximately parallel to the surface of the metal housing 110, thereby making it convenient to affix insulation tape outside the circuit board 40 or perform low-pressure injection molding on the circuit board 40 to form a protective body. In addition, the installation space occupied by the circuit board 40 is reduced, and in turn, the space occupied by the metal-shell battery is reduced, thereby meeting miniaturization and lightweight requirements of the metal-shell battery.

For the metal housing 110 above, still referring to FIG. 1, the metal housing 110 includes a first sidewall 111, a second sidewall 112, a third sidewall 113, a fourth sidewall 114, a fifth sidewall 115, and a sixth sidewall 116. The first sidewall 111, the second sidewall 112, the third sidewall 113, and the fourth sidewall 114 are connected in sequence, and are connected to the oppositely disposed fifth sidewall 115 and sixth sidewall 116 separately to circumferentially form a closed space that is used to accommodate the cell 20. For ease of description, in this embodiment of this application, a surface of the first sidewall 111, a surface of the second sidewall 112, a surface of the third sidewall 113, a surface of the fourth sidewall 114, a surface of the fifth sidewall 115, and a surface of the sixth sidewall are defined as a first lateral surface, a second lateral surface (not shown), a third lateral surface (not shown), a fourth lateral surface (not shown), a fifth lateral surface, and a sixth lateral surface (not shown) of the metal housing 110. The first surface 111a is the first lateral surface that is of the metal housing 110 and that is close to the circuit board 40. The second surface 115a is the fifth lateral surface that is disposed adjacent to the first surface 111a and that is of the metal housing 110.

Understandably, the material and shape of the metal housing 110 are adaptively adjustable according to actual needs. For example, in this embodiment of this application, the metal-shell battery is installed inside a frame of a smart wearable device as a power supply of the smart wearable device. Therefore, in order to achieve high mechanical performance of the metal-shell battery, the material of the metal housing 110 may be steel alloy, and the shape of the metal housing 110 is approximately a cuboid. Definitely, in other embodiments of this application, the material of the metal housing 110 may be aluminum alloy, iron alloy, copper alloy, nickel alloy, stainless steel, or the like instead, and the shape of the metal housing 110 may be a regular structure such as a columnar structure instead.

Further, still referring to FIG. 2, a first opening 110a and a second opening 110b are made on the metal housing 110. The first opening 110a and the second opening 110b communicate with each other in a closed space. The first opening 110a is configured to replenish or replace an electrolytic solution of the cell 20. The second opening 110b is configured to allow passage of a positive electrode of the cell 20. It is hereby noted that, in order to prevent the injected electrolytic solution 140 from leaking out or to prevent external impurities from entering the closed space, a plug 117 is further disposed at the first opening 110a in this embodiment of this application. The plug 117 is configured to hermetically seal the first opening 110a. In addition, in order to avoid a short circuit between the positive electrode and a negative electrode of the cell 20, an insulation spacer 118 is further disposed at the second opening 110b in this embodiment of this application. The insulation spacer 118 is configured to insulate the positive electrode from the negative electrode of the cell 20 and also prevent the electrolytic solution 140 from leaking out of the second opening 110b.

Understandably, positions of the first opening 110a and the second opening 110b are adaptively adjustable according to actual needs. For example, in this embodiment of the application, in order to reduce processing steps of the metal housing 110, the first opening 110a and the second opening 110b can be drilled on the same surface of the metal housing 110 by using processing equipment without a need to adjust a posture of fixing the metal housing 110. For example, the surface is the first surface 111a. Further, the first opening 110a is located at an end that is of the first surface 111a and that is close to the second lateral surface 120a. The second opening 110b is located at an end that is of the first surface 111a and that is close to the fourth lateral surface 140a. Definitely, in other embodiments of this application, the first opening 110a and the second opening 110b may be located on different surfaces of the metal housing 110 instead.

For the cell 20, referring to FIG. 3, the cell 20 further includes a positive tab 131, a negative tab 132, and an electrolytic solution 140. The electrolytic solution 140 is accommodated in a closed space inside the metal housing 110. The electrode assembly 120 is infiltrated in the electrolytic solution 140. One end of the positive tab 131 and one end of the negative tab 132 are electrically connected to the electrode assembly 120 separately. The other end of the positive tab 131 protrudes from the first opening 110b in the form of an electrode post. Preferably, a cross section of the electrode post is a circular or rectangular shape, and a gap exists between an end surface of an end that is of the electrode post and that is away from the positive tab 131 and the first surface 111a. The other end of the negative tab 132 is electrically connected to any sidewall of the metal housing 110.

Specifically, the electrode assembly 120 is a stacked structure. The electrode assembly 120 includes a positive electrode plate 121, a negative electrode plate 122, and a separator 123. The positive electrode plate 121 and the negative electrode plate 122 are alternately stacked. A separator 123 is disposed between any adjacent positive electrode plate 121 and negative electrode plate 122.

Understandably, the number of layers of the positive electrode plate 121 and the negative electrode plate 122 is not limited, and is adaptively adjustable according to actual needs. For example, in this embodiment of this application, to minimize the space occupied by the cell 20, the number of layers of the positive electrode plate 121 and the negative electrode plate 122 is preferably 1 or 2. Definitely, in other embodiments of this application, the number of layers of the positive electrode plate 121 and the negative electrode plate 122 may be more than 3 instead. In addition, in order to make the electrolytic solution 140 infiltrate the electrode assembly 120 thoroughly and improve an energy density of the metal-shell battery, in other embodiments of this application, the electrode assembly 120 may be a jelly-roll structure instead. That is, a jelly-roll cell is formed. In sealing the electrode assembly 120, due to a gap between the electrode assembly 120 and the metal housing 110, the electrolytic solution 140 can easily flow through the gaps and enter the stacked layers of the electrode assembly 120.

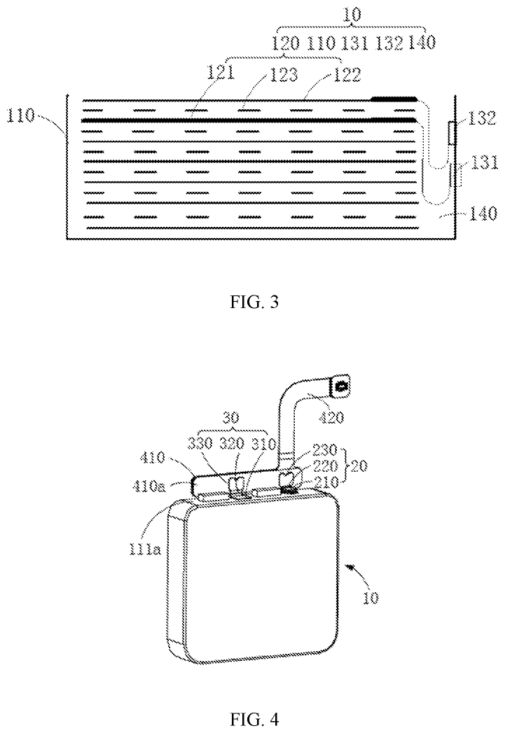

For the first conductive sheet 20, referring to FIG. 3 and FIG. 4 together, the first conductive sheet 20 includes a first fixing portion 210, a first connecting portion 220, and a second fixing portion 230. The first fixing portion 210 is disposed at one end of the first connecting portion 220. The second fixing portion 230 is disposed at the other end of the first connecting portion 220. The first fixing portion 210 is disposed at an angle to the second fixing portion 230. The first fixing portion 210 is connected to an end surface that is of the electrode post and that is away from the positive tab 131. The second fixing portion 230 is connected to the circuit board 40.

Understandably, the material and structure of the first conductive sheet 20 are adaptively adjustable according to actual needs. For example, in this embodiment of this application, due to a relatively small gap between the electrode post and the circuit board 40, for ease of fixing the first conductive sheet 20 between the electrode post and the circuit board 40, the material of the first conductive sheet 20 may be nickel alloy, and the shape of the first conductive sheet 20 is approximately a cuboid. Definitely, in other embodiments of this application, the material of the first conductive sheet 20 may be copper alloy or aluminum alloy instead, and the shape of the first conductive sheet 20 may be a regular structure such as a strip shape or a block shape instead.

Understandably, the electrode post may be connected to the circuit board 40 by a means other than the first conductive sheet 20. For example, in other embodiments of this application, the gap between the electrode post and the circuit board 40 is filled with tin so that the electrode post is directly welded and fixed onto the circuit board 40 to implement electrical connection between the electrode post and the circuit board 40.

For the second conductive sheet 30, the second conductive sheet 30 includes a third fixing portion 310, a second connecting portion 320, and a fourth fixing portion 330. The third fixing portion 310 is disposed at one end of the second connecting portion 320. The fourth fixing portion 330 is disposed at the other end of the second connecting portion 320. The third fixing portion 310 is disposed at an angle to the fourth fixing portion 330. The third fixing portion 310 is connected to the first surface 111a. The fourth fixing portion 330 is connected to the circuit board 40.

Understandably, the material and structure of the second conductive sheet 30 are adaptively adjustable according to actual needs. For example, in this embodiment of this application, due to a relatively small gap between the first surface 111a and the circuit board 40, for ease of fixing the second conductive sheet 30 between the first surface 111a and the circuit board 40, the material of the second conductive sheet 30 may be nickel alloy, and the shape of the second conductive sheet 30 is approximately a cuboid. Definitely, in other embodiments of this application, the material of the second conductive sheet 30 may be copper alloy or aluminum alloy instead, and the shape of the second conductive sheet 30 may be a regular structure such as a strip shape or a block shape instead.

Understandably, the first surface 111a may be connected to the circuit board 40 by a means other than the second conductive sheet 30. For example, in other embodiments of this application, the gap between the first surface 111a and the circuit board 40 is filled with tin so that the first surface 111a is directly welded and fixed onto the circuit board 40 to implement electrical connection between the first surface 111a and the circuit board 40.

In addition, in order to ensure that just a small plastic deformation occurs when the circuit board 40 is disposed at an angle to the first surface 111a, in this embodiment of the application, preferably, one of the first conductive sheet 20 or the second conductive sheet 30 may be of relatively high strength. Correspondingly, the strength of the other of the first conductive sheet 20 or the second conductive sheet 30 may be equal to or slightly lower than the strength of the former conductive sheet.

For the circuit board 40, still referring to FIG. 1 and FIG. 2, the circuit board 40 includes a circuit board body 410 and a first plane 410a. The first plane 410a is located on a side that is of the circuit board body 410 and that faces the first surface 111a. Bonding pads are disposed on the first plane 410a. The second fixing portion 230 and the fourth fixing portion 330 are connected to the bonding pads in one-to-one correspondence respectively. An output terminal 420 is disposed on the circuit board body 410. Preferably, each bonding pad is in a sheet-like shape. The output terminal 420 is a flexible circuit board 40.

Understandably, a trace mode of the output terminal 420 is adaptively adjustable according to actual needs. Alternatively, the output terminal 420 may be replaced by other materials, details of which are omitted here.

To facilitate balancing of the circuit board body 410 relative to the first surface 111a, in some embodiments, the metal-shell battery further includes an insulation filler 50. One end of the insulation filler 50 is connected to the first surface 111a. The other end of the insulation filler 50 is connected to the first plane 410a. Preferably, the number of insulation fillers 50 is two, of which one insulation filler 50 is located between the first conductive sheet 20 and the second conductive sheet 30, and the other insulation filler 50 is located at a side that is of the second conductive sheet 30 and that is close to the fourth lateral surface 140a. The insulation fillers 50 may be foam, silicone, or plastic. With the insulation filler 50 disposed between the circuit board and the first surface, the spacing between the circuit board and the first surface can be controlled more precisely, so that the circuit board is approximately parallel to the first surface.

To seal the circuit board 40, the first conductive sheet 20, and the second conductive sheet 30 in such a way that they are located outside the metal housing 110, in some embodiments, the metal-shell battery further includes a protection piece 70. The protection piece 70 is adhered onto the first surface 111. The protection piece 70 at least partly overlays the circuit board 40. Preferably, the protection piece 70 completely coats the circuit board 40, the first conductive sheet 20, and the second conductive sheet 30. In some embodiments, the protection piece 70 is directly formed on the first surface 111a by means of low-pressure injection molding, thereby increasing connection strength between the circuit board 40 and the cell 10 and improving protection effects on the circuit board 40.

For ease of understanding the content of the first embodiment of this application, the following describes the content with reference to a process flow of assembling a pack of a metal-shell battery.

S1: Space the circuit board 40 apart from the first surface 111a by letting the first plane 410a be perpendicular to the first surface 111a. First, place the first conductive sheet 20 between the electrode post and the circuit board 40, and then weld and fix the first conductive sheet 20 onto a bonding pad between the electrode post and the circuit board 40 by welding.

S2: Place the second conductive sheet 30 between the first surface 111a and the circuit board 40, and then weld and fix the second conductive sheet 30 onto a bonding pad between the first surface 111a and the circuit board 40 by welding.

S3: Dispose a filler between the first plane 410a and the first surface 111a.

S4: Bend the first conductive sheet 20 and the second conductive sheet 30 so that the first plane 410a is parallel to the first surface 111a.

S5: Perform potting, adhesive dispensing, or low-pressure injection molding to form a protection piece 70 to seal the circuit board 40, the first conductive sheet 20, and the second conductive sheet 30 on the first surface 111a.

S6: Form the output terminal 420 by bending a flexible printed circuit (FPC), so that the other end of the output terminal 420 protrudes from the second lateral surface 120a.

Understandably, through step S4, the first plane 410a of the circuit board 40 closely fits the first surface 111a to minimize the gap between the first plane 410a and the first surface 111a in a width direction of the circuit board 40. Preferably, an angle α1 between the first plane 410a and the first surface 111a in the width direction of the circuit board 40 is 0°. In other words, the first plane 410a is disposed parallel to the first surface 111a along the width direction of the circuit board 40. However, due to a problem of a packaging tolerance that unavoidably arises from the bending of the first conductive sheet 20, the second conductive sheet 30, and the circuit board 40 in step S4, the first plane 410a of the circuit board 40 is disposed at an angle to the first surface 111a in the width direction of the circuit board 40. To be specific, the angle α1 between the first plane 410a and the first surface 111a satisfies: 0°≤α1≤30°. The angle falling within such a range can meet requirements in practical applications.

Further, understandably, an area of an orthographic projection of the protection piece 70 obtained in step S5 on the first surface 111a is smaller than a surface area of the first surface 111a. In other words, when the protection piece 70 is adhered to the metal housing 110, a surface of the protection piece 70 partly overlays the first surface 111a. In this way, when the protection piece 70 is plugged to an external device equipped with a socket that matches the protection piece 70, the metal-shell battery can be fixed onto the external device more firmly.

In this embodiment of this application, the first conductive sheet 20 and the second conductive sheet 30 are disposed between the circuit board 40 and two electrodes of the cell 20 respectively, so that a plane in which the circuit board 40 is located is approximately parallel to the first surface 111a of the cell 20. In contrast to the prior art, this embodiment of this application reduces the installation space occupied by the circuit board 40, and in turn, reduces the space occupied by the metal-shell battery, thereby meeting the miniaturization and lightweight requirements of the metal-shell battery.

In addition, the insulation filler 50 disposed between the circuit board 40 and the first surface 111a can not only support the circuit board 40, but also effectively avoid skew of the circuit board in a process of bending the first conductive sheet 20 and the second conductive sheet 30.

Referring to FIG. 4, which shows a metal-shell battery according to a second embodiment of this application. The second embodiment differs from the first embodiment in that the step of bending the first conductive sheet 20 and the second conductive sheet 30 and the step of forming the output terminal 420 by bending an FPC in the process of assembling the pack of the metal-shell battery are omitted.

In the second embodiment, the first plane 410a is disposed at an angle to the first surface 111a, and the angle α2 between the first plane 410a and the first surface 111a satisfies: 80°≤α2≤100°. Preferably, the angle α2 between the first plane 410a and the first surface 111a is 90°, that is, the first plane 410a is perpendicular to the first surface 111a in the length direction of the circuit board.

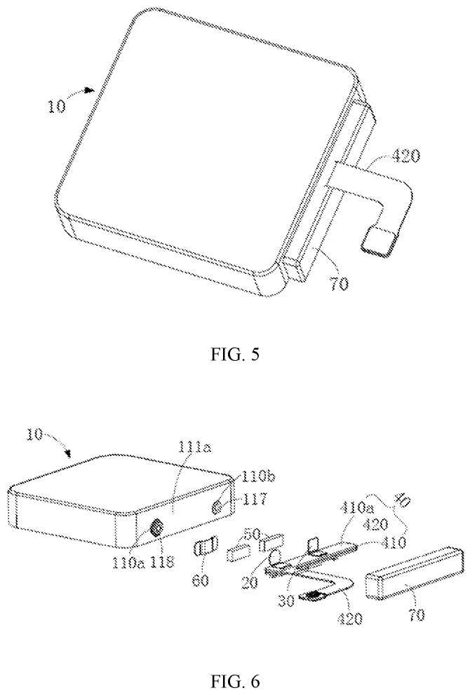

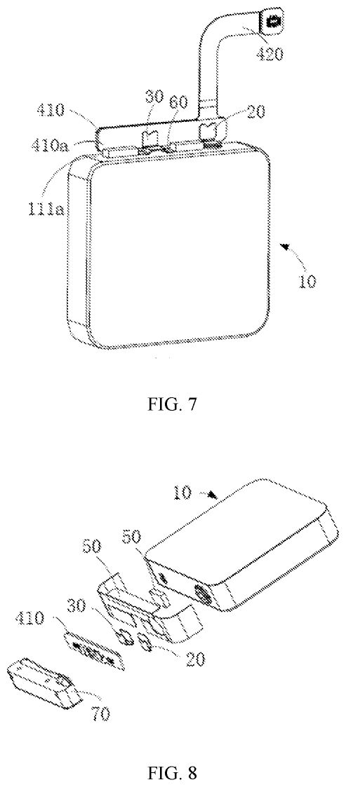

Referring to FIG. 5 to FIG. 7 together, which show a metal-shell battery according to a third embodiment of this application. The third embodiment differs from the first embodiment in a manner of connection between the second conductive sheet 30 and the first surface 111a.

In the third embodiment, the metal-shell battery further includes a pantograph strip 60. A flat portion of the pantograph strip 60 is disposed on the first surface 111a. A raised portion of the pantograph strip 60 is away from the first surface 111a. The first fixing portion 210 is connected to the raised portion. With the pantograph strip 60 in use, a weld point of the first conductive sheet 20 and a weld point of the second conductive sheet 30 are approximately located at the same height. In this way, by means of laser welding, the first conductive sheet 20 and the second conductive sheet 30 can be welded in the same process, without producing different welding effects due to different laser effecting distances caused by different welding heights of the two conductive sheets. Preferably, the first fixing portion 210 snugly fits a surface that is of the raised portion and that is away from the first surface 111a. The pantograph strip 60 may be made of steel alloy or stainless steel. Understandably, the insulation filler 50 are adaptively adjustable according to actual needs.

Referring to FIG. 8, which shows a metal-shell battery according a fourth embodiment of this application. The fourth embodiment differs from the first embodiment in that the insulation filler 50 is replaced with insulation tape.

In the fourth embodiment, the insulation filler 50 between the first surface 111a and the first plane 410a is replaced with the insulation tape 80. Preferably, the insulation tape 80 is an integrated structure. Two through-holes are made on the insulation tape to facilitate exposure of the first conductive sheet 20 and the second conductive sheet 30. Two opposite sides of the insulation tape are connected to the second lateral surface 120a and the fourth lateral surface 140a respectively. A side located between the two opposite sides of the insulation tape is connected to the second surface 115a, thereby preventing direct electrical contact between the circuit board 40 and the metal housing 110.

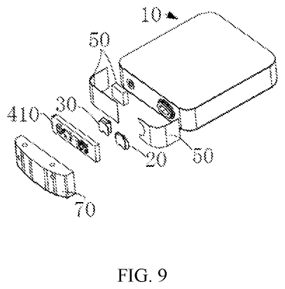

Referring to FIG. 9, which shows a metal-shell battery according to a fifth embodiment of this application. The fifth embodiment differs from the fourth embodiment in that the insulation tape located between the first surface 111a and the first plane 410a is a discrete structure.

This application further provides an electronic device, including the metal-shell battery described above. For a specific structure and functions of the metal-shell battery, refer to the foregoing embodiments, details of which are not repeated herein. The electronic device may be a mobile electronic device, an energy storage device, an electric vehicle, a hybrid electric vehicle, or the like. The mobile device may be a mobile phone, a wearable electronic device, a tablet computer, a notebook computer, or the like.

What is described above is merely embodiments of this application, and is not to hereby limit the patent scope of this application. All equivalent structural variations and equivalent process variations made by using the content of the specification and the drawings hereof, and any direct and indirect use of the content hereof in other related technical fields, fall within the patent protection scope of this application.

What is claimed is:

1. A metal-shell battery, comprising:
a cell comprising a metal housing and an electrode assembly sealed in the metal housing, wherein the metal housing comprises a first surface, an electrode post is extended on the first surface, the electrode post is insulated from the metal housing, and two electrodes of the electrode assembly are electrically connected to the electrode post and the metal housing respectively; wherein the metal-shell battery further comprises:
a first conductive sheet, wherein one end of the first conductive sheet is connected to the first surface;
a second conductive sheet, wherein one end of the second conductive sheet is connected to the electrode post; and
a circuit board connected to an other end of the first conductive sheet and an other end of the second conductive sheet respectively, a distance between one end of the circuit board along a length direction of the circuit board and the first surface is a first spacing S1, a distance between the other end of the circuit board along the length direction of the circuit board and the first surface is a second spacing S2, and |S1-S2|≤1 mm.

2. The metal-shell battery according to claim 1, wherein the circuit board comprises a first plane; and
the other end of the first conductive sheet and the other end of the second conductive sheet are both connected to the first plane.

3. The metal-shell battery according to claim 2, wherein the first plane is disposed at an angle α1 to the first surface, and 0°≤α1≤30°.

4. The metal-shell battery according to claim 2, wherein the first plane is disposed at an angle α2 to the first surface, and 80°≤α2≤100°.

5. The metal-shell battery according to claim 1, further comprising an insulation filler, and the insulation filler is disposed between the first surface and the circuit board.

6. The metal-shell battery according to claim 1, further comprising a pantograph strip, the pantograph strip is disposed on the first surface, and one end of the first conductive sheet is connected to the first surface by the pantograph strip.

7. The metal-shell battery according to claim 1, further comprising a protection piece, the protection piece is disposed on the first surface, and the protection piece at least partly overlays the circuit board.

8. The metal-shell battery according to claim 7, wherein the protection piece is formed by a potting process, an adhesive dispensing process, or a low-pressure injection molding process.

9. The metal-shell battery according to claim 7, wherein
the circuit board comprises a circuit board body and an output terminal, one end of the output terminal is connected to the circuit board body, and an other end of the output terminal protrudes from the protection piece.

10. An electronic device comprising the metal-shell battery according to claim 1.
